(19) United States
(12) Patent Application Publication
(10) Pub. No.: US 2011/0153940 A1
(43) Pub. Date: Jun. 23, 2011

(54) METHOD AND APPARATUS FOR COMMUNICATING DATA BETWEEN PROCESSORS IN MOBILE TERMINAL

(75) Inventor: Jin Hyung LEE, Seoul (KR)

(73) Assignee: SAMSUNG ELECTRONICS CO. LTD., Suwon-si (KR)

(21) Appl. No.: 12/976,386

(22) Filed: Dec. 22, 2010

(30) Foreign Application Priority Data
Dec. 22, 2009 (KR) 10-2009-0128783

(51) Int. Cl. G06F 12/00

(52) U.S. Cl. 711/118; 711/E12.001

(57) ABSTRACT

A data communication method between processors in a portable terminal and an apparatus thereof are provided. The method includes storing data to be transmitted from a first processor to a second processor in a transmission buffer, determining a size of a free space in a shared memory, sequentially transmitting the data stored in the transmission buffer to the shared memory in units of the size of the free space to the shared memory, and reading out the data transmitted to the shared memory and storing the read data in a reception buffer by a second processor.

### PRIORITY

This application claims the benefit under 35 U.S.C. §119(a) of a Korean patent application filed on Dec. 22, 2009 in the Korean Intellectual Property Office and assigned Ser. No. 10-2009-0128783, the entire disclosure of which is hereby incorporated by reference.

### BACKGROUND OF THE INVENTION

1. Field of the Invention

The present invention relates to a data communication method in a portable terminal and an apparatus thereof More particularly, the present invention relates to a data communication method capable of improving data communication efficiency between processors in a portable terminal, and an apparatus thereof.

2. Description of the Related Art

In general, a portable terminal usually includes only a single processor, and the processor processes all the functions of the portable terminal. However, as the portable terminal gradually evolves to become a multi-media device, it becomes difficult to process the all the function of the portable terminal by one processor. Accordingly, a portable terminal including two processors has been developed. Further, as a multi-standby terminal capable of communicating with two wireless communication networks is developed, a portable terminal including a plurality of processors has become more common.

The foregoing portable terminal includes a shared memory, for example, a Dual-Port Random Access Memory (DPRAM) for data communication between two processors. A buffer area for data transmission is allotted to the shared memory for the processors. A respective processor transmits data to another processor through the allotted buffer area. When data communication between conventional processors is to occur, an amount of free space in the shared memory is determined. A queue process scheme for transmitting the data is used only when there is a free space equal to or greater than data to be transmitted to the shared memory. This has a problem in that it sometimes cannot transmit data even when a free space exists in the shared memory. Accordingly, there is a problem in that data communication between conventional processors depends on performance and capacity of the shared memory.

Meanwhile, as various functions are additionally provided and the performance of processors is improved, processors of a portable terminal can transmit large amounts of data. Because the conventional communication method depends on the performance and capacity of the shared memory, when transmitting a large amount of data, a bottleneck occurs which deteriorates the performance of a system. To solve the problem, a capacity of the shared memory can be increased. However, this increases a cost of the portable terminal due to an expensive cost of the shared memory.

### SUMMARY OF THE INVENTION

An aspect of the present invention is to address at least the above-mentioned problems and/or disadvantages and to provide at least the advantages described below. Accordingly, an aspect of the present invention is to provide a data communication method that may efficiently perform data communication between processors in a portable terminal with a plurality of processors, and an apparatus thereof.

In accordance with an aspect of the present invention, a data communication method between processors in a portable terminal with a plurality of processors is provided. The method includes storing data to be transmitted from a first processor to a second processor in a transmission buffer, determining a size of a free space in a shared memory, sequentially transmitting the data stored in the transmission buffer to the shared memory in units of the size of the free space, and reading out the data transmitted to the shared memory and storing the read out data in a reception buffer by a second processor.

In accordance with another aspect of the present invention, a data communication apparatus between processors in a portable terminal with a plurality of processors is provided. The apparatus includes, a transmission buffer for sequentially storing data that a first processor requests transmission of to a second processor, a shared memory for performing a function of a medium for data communication between the first processor and the second processor, a reception buffer for receiving and storing the data stored in the transmission buffer through the shared memory, the first processor for determining a size of a free space of the shared memory and for controlling transmission of data stored in the transmission buffer to the shared memory in units of the size of the free space, and the second processor for reading out the data stored in the shared memory and for controlling the reception buffer to store the read out data.

As mentioned above, a data communication method between processors in a portable terminal and an apparatus thereof according to exemplary embodiments of the present invention can transmit and receive data in units of the size of a free space in a shared memory to enable data communication between the processors. This acts to prevent bottleneck to secure stability of the portable terminal, and to prevent deterioration of a performance due to the bottleneck. In addition, the exemplary embodiments of the present invention provide efficient data communication using a shared memory of a relative small capacity, which reduces a cost of the portable terminal.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a block diagram schematically illustrating a configuration of a portable terminal including a plurality of processors according to an exemplary embodiment of the present invention;

FIG. 2 is a flowchart illustrating a data communication method between processors of a portable terminal according to an exemplary embodiment of the present invention; and

FIG. 3 is a block diagram illustrating data flow according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Hereinafter, a portable terminal according to an exemplary embodiment of the present invention includes a plurality of processors, and preferably is a mobile communication terminal. Besides this, the portable terminal may, for example, be a digital broadcasting terminal, a Personal Digital Assistant (PDA), or a smart phone. A multi-standby terminal including a plurality of processors may be used as the mobile communication terminal.

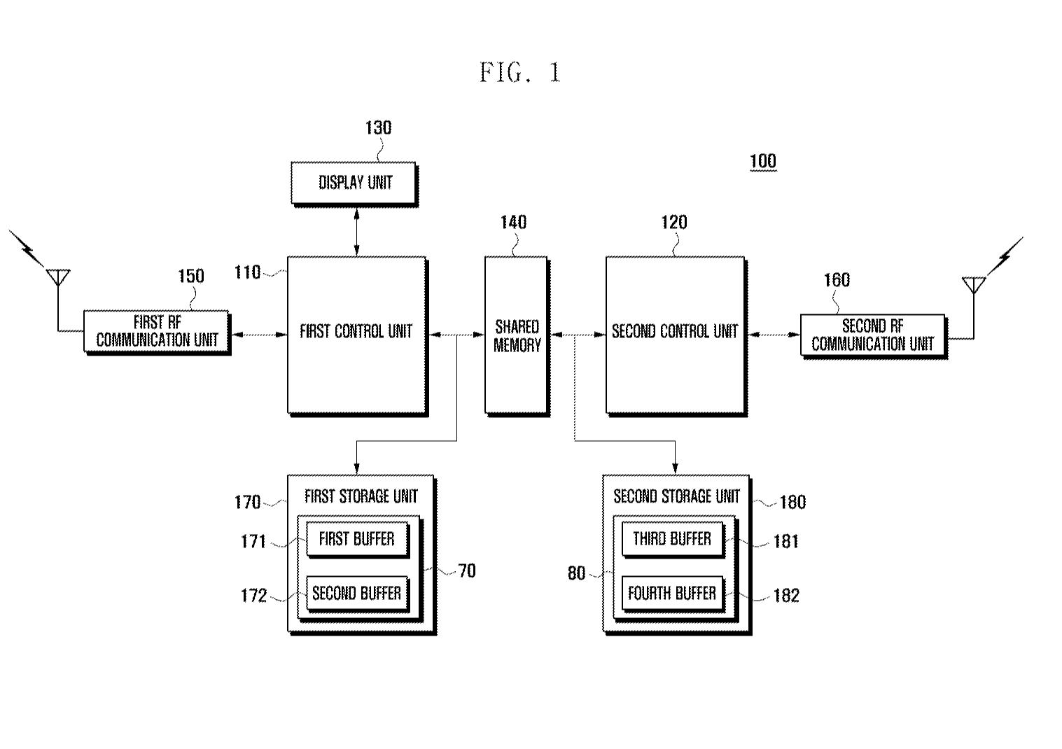

FIG. 1 is a block diagram schematically illustrating a configuration of a portable terminal including a plurality of processors according to an exemplary embodiment of the present invention. Hereinafter, for convenience in description, a dual standby terminal will be described as an example of the portable terminal according to an exemplary embodiment of the present invention.

Referring to FIG. 1, a portable terminal 100 may include a first control unit 110, a second control unit 120, a display unit 130, a shared memory 140, a first Radio Frequency (RF) communication unit 150, a second RF communication unit 160, a first storage unit 170, and a second storage unit 180. The first storage unit 170 includes a transmission buffer 70 with a first buffer 171 and a second buffer 172. The second storage unit 180 includes a reception buffer 80 with a third buffer 181 and a fourth buffer 182.

The first RF communication unit 150 executes transmitting and receiving functions of data for a first RF communication service of the portable terminal 100. The first RF communication unit 150 may include an RF transmitter (not shown) for up-converting a frequency of a transmitted signal and amplifying the signal, and an RF receiver (not shown) for low-noise-amplifying a received signal and down-converting the signal. Further, the first RF communication unit 150 may receive data through an RF channel and output the received data to the first control unit 110. The first RF communication unit 150 may transmit data provided from the first control unit 110 to a base station through the RF channel.

The second RF communication unit 160 executes transmitting and receiving functions of data for a second RF communication service of the portable terminal 100. The second RF communication unit 160 may include an RF transmitter (not shown) for up-converting a frequency of a transmitted signal and amplifying the signal, and an RF receiver (not shown) for low-noise-amplifying a received signal and down-converting the signal. Further, the second RF communication unit 160 may receive data through an RF channel and output the received data to the second control unit 120. The second RF communication unit 160 may transmit data provided from the second control unit 120 to the base station through the RF channel. Namely, the second RF communication unit 160 may execute the same function as that of the first RF communication unit 150. Here, the second RF communication service may use the same or a different protocol as or from that of the first RF communication service. For example, the first RF communication service and the second RF communication service may use the same protocol as in Global System for Mobile communication (GSM)-GSM or a different protocol as in Code Division Multiple Access (CDMA)-GSM.

The display unit 130 may display user data, function setting information input by a user, various information provided to the user, and all kinds of menu screens of the portable terminal. For example, the display unit 130 may output a booting screen, an idle screen, a menu screen, and a video phone call screen. The display unit 130 can be configured, for example, by Liquid Crystal Display (LCD), Organic Light Emitting Diode (OLED), or Active Matrix Organic Light Emitting Diode (AMOLED). Further, when the display unit 130 is configured by a touch-screen form, it can also operate as an input unit (not shown).

The first storage unit 170 and the second storage unit 180 may store a program necessary for an operation of the portable terminal 100, an application and data necessary in other optional functions, for example, a digital broadcasting play function or a near distance communication function. For example, the first storage unit 170 may store an Operating System (OS) of a portable terminal 100, a program for providing a first RF communication service, and an application program based on the first RF communication service. The second storage unit 180 may store a program for providing a second RF communication service and an application program based on the second RF communication service. The first storage unit 170 and the second storage unit 180 can be configured, for example, by a volatile storage medium, a nonvolatile storage medium, or a combination thereof.

In particular, the first storage unit 170 according to an exemplary embodiment of the present invention includes a transmission buffer 70 sequentially storing data that the first control unit 110 requests transmission of to the second control unit 120. The second storage unit 180 may include a reception buffer 80 receiving and storing data from the first control unit 110 through a shared memory 140. The transmission buffer 70 according to an exemplary embodiment of the present invention includes a first buffer 171 and a second buffer 172. The reception buffer 80 may include a third buffer 181 and a fourth buffer 182. Here, the transmission buffer 70 and the reception buffer 80 are a relative concept. That is, when the second control unit 120 requests data transmission to the first control unit 110, the transmission buffer 70 may execute a function of the reception buffer 80, and the reception buffer 80 may execute a function of the transmission buffer 70.

When the first control unit 110 requests data transmission to the second control unit 120, the first buffer 171 may store the requested transmission data. At this time, the first buffer 171 may store data in a circular queue scheme. Further, the first buffer 171 may add a header to data and store the data with header under the control of the first control unit 110. The header stores information regarding data type. For example, information regarding data type such as ‘incoming call’ or ‘outgoing call’ may be stored in the header in a case of call data. Information regarding data type such as ‘SMS’ may be stored in the header in a case of Short Messaging Service (SMS). In the meantime, when the second control unit 120 requests data transmission to the first control unit 110, the first buffer 171 can execute functions of a fourth buffer 182 to be illustrated below.

The second buffer 172 may receive and store data stored in the first buffer 171. At this time, the data stored in the second buffer 172 may be converted and stored according to Inter Process Communication (IPC) communication format. For example, the second buffer 172 may add a start flag indicating a start part of data and an end flag indication an end of data according to a High-level Data Link Control (HDLC) communication format, and perform byte stuffing and bit stuffing. The HDLC transmission format is known in the art, and thus the detailed description thereof is appropriately omitted.

Conversion data stored in the second buffer 172 are transmitted to a shared memory 140 in units of the size of a free space of the shared memory 140 under the control of the first control unit 110. That is, unlike data transmission of the related art, although a free space larger than the size of data to be transmitted does not exist in the shared memory 140, an exemplary embodiment of the present invention can still transmit the data. Meantime, when the second control unit 120 requests data transmission to the first control unit 110, the second buffer 172 can perform a function of a third buffer 181 to be illustrated below.

The third buffer 181 may receive and store data transmitted to the shared memory 140 from the second buffer 172 under the control of the second control unit 120. In this case, the third buffer 181 may sequentially receive and store an amount of data corresponding to its sharing space from the shared memory 140. Subsequently, when the third buffer 181 receives one complete unit of data including a start flag and an end flag, it can transmit the complete unit of data to the fourth buffer 182. In this case, the data stored in the third buffer 181 can be transmitted to the fourth buffer 182 by an inversion procedure of conversion performed when transmitting the data from the first buffer 171 to the second buffer 172. In the meantime, when the second control unit 120 requests data transmission to the first control unit 110, the third buffer 181 can execute a function of the second buffer 172 to be illustrated above.

The fourth buffer 182 may store data provided from the third buffer 181. Next, data stored in the fourth buffer 182 can be transmitted to a software module (e.g., task) processing the data under the control of the second control unit 120. For example, when the data includes outgoing call data, the data is transmitted to a software module performing a call function. The software module performing the call function can transmit a call request signal to a base station through the second RF communication unit 160 using another user's phone number included in the data. In the meantime, when the second control unit 120 requests data transmission to the first control unit 110, the fourth buffer 182 can execute a function of the first buffer 171 to be illustrated above.

Meanwhile, capacities of the first buffer 171 to the fourth buffer 182 can be optimized according to a system performance of a portable terminal 100 through testing. Although the first storage unit 170 and the second storage unit 180 are separately shown in FIG. 1 as two separate units, they can be included in one memory in a separated form.

The shared memory 140 is a medium for data communication between the first control unit 110 and the second control unit 120. The shared memory 140 according to an exemplary embodiment of the present invention may be a Dual-Ported Random Access Memory (DPRAM). The shared memory 140 may include a buffer area storing data and an interrupt area. When the shared memory 140 receives a write interrupt from the first control unit 110, it may receive data from the second buffer 172, store the received data in the buffer area, and transmit a read interrupt to the second control unit 120. Next, the shared memory 140 may transmit data stored in the data area to the third buffer 181 under the control of the second control unit 120. The shared memory 140 can perform a reverse operation of the foregoing procedure performed at the time of receiving a write interrupt from the second control unit 120.

The first control unit 110 and the second control unit 120 control an operation of the portable terminal 100. For example, the first control unit 110 may control a first RF communication service and a function using the first RF communication service. The second control unit 120 may control a second RF communication service and a function using the second RF communication service. In this case, the first control unit 110 may be a main controller controlling an overall operation of the portable terminal 100. The first control unit 110 and the second control unit 120 can be configured by different processors, respectively. For example, the first control unit 110 and the second control unit 120 can be configured by different processors for a mobile communication service of a CDMA-GSM scheme. Further, the first control unit 110 can be configured by a processor for a mobile communication service and the second control unit 120 can be configured by a processor for providing a portable computer function.

In particular, the first control unit 110 according to an exemplary embodiment of the present invention can sense an event generation requesting transmission of data to the second control unit 120. At this time, the first control unit 110 may transmit the data to the first buffer 171 that controls the first buffer 171 to store the data. The first control unit 110 may add a header to the data, and store the data with the header in the first buffer 171. Next, the first control unit 110 may convert the received data into a set data format for IPC communication, for example, an HDLC format, and control the first buffer 171 to transmit the converted data to the second buffer 172.

The first control unit 110 checks whether there is a free space in the shared memory 140. When there is the free space in the shared memory 140, the first control unit 110 transmits a write interrupt signal to the shared memory 140 and transmits an amount of data stored in the second buffer 172 and corresponding to the checked free space to the shared memory 140. At this time, when the shared memory 140 receives the write interrupt signal, it transmits a read interrupt signal to the second control unit 120.

When the second control unit 120 receives the read interrupt signal, it may read out data stored in the shared memory 140 and store the read data in the third buffer 181. Subsequently, when one complete data unit including a start flag and an end flag is transmitted to the third buffer 181, the second control unit 120 inverts the one complete data unit and controls transfer of the converted complete data to the fourth buffer 182. The second control unit 120 identifies a header of data stored in the fourth buffer 182 to execute a corresponding function. For example, when the data type is outgoing call data, the second control unit 120 may transmit the data to a software module performing a call function, and the software module may transmit a call request signal to a base station using another user's phone number included in the data through the second RF communication unit 160.

Meanwhile, the foregoing exemplary embodiment has been described that the first control unit 110 transmits data to the second control unit 120 by way of example. However, the present invention is also applicable to a case where the second control unit 120 transmits the data to the first control unit 110.

The portable terminal 100 according to an embodiment of the present invention having the construction mentioned above can transmit an amount of data corresponding to a current free space of the shared memory 140, regardless of the total amount of the data to be transmitted, to prevent bottleneck of data transmission due to a lack free space of the shared memory 140. Furthermore, an exemplary embodiment of the present invention may transmit mass data by controlling capacities of a first buffer 171 to a fourth buffer 182 of a relative low cost without increasing a capacity of the shared memory 140, thereby reducing a cost of the portable terminal.

In the meantime, although not shown, the portable terminal 100 may further include structural elements having additional functions such as a camera module for photographing still images or moving images, a near distance communication module for near distance wireless communication, a broadcast receiving module for receiving broadcasts, a digital sound source module such as a Motion Picture Experts Group (MPEG) Audio Layer 3 (MP3) module, and an Internet communication module. Since the structural elements can be variously changed according to convergence trends of digital devices, no elements can be definitively listed. However, the portable terminal 100 may include structural elements equivalent to the foregoing structural elements.

A configuration of the portable terminal 100 according to an exemplary embodiment of the present invention has been described above. Hereinafter, a method for performing data communication between processors of the portable terminal 100 will be explained. A following exemplary embodiment will be described when the first control unit 110 transmits data to the second control unit 120 by way of example. However, the present invention is also applicable to a case where the second control unit 120 transmits data to the first control unit 110.

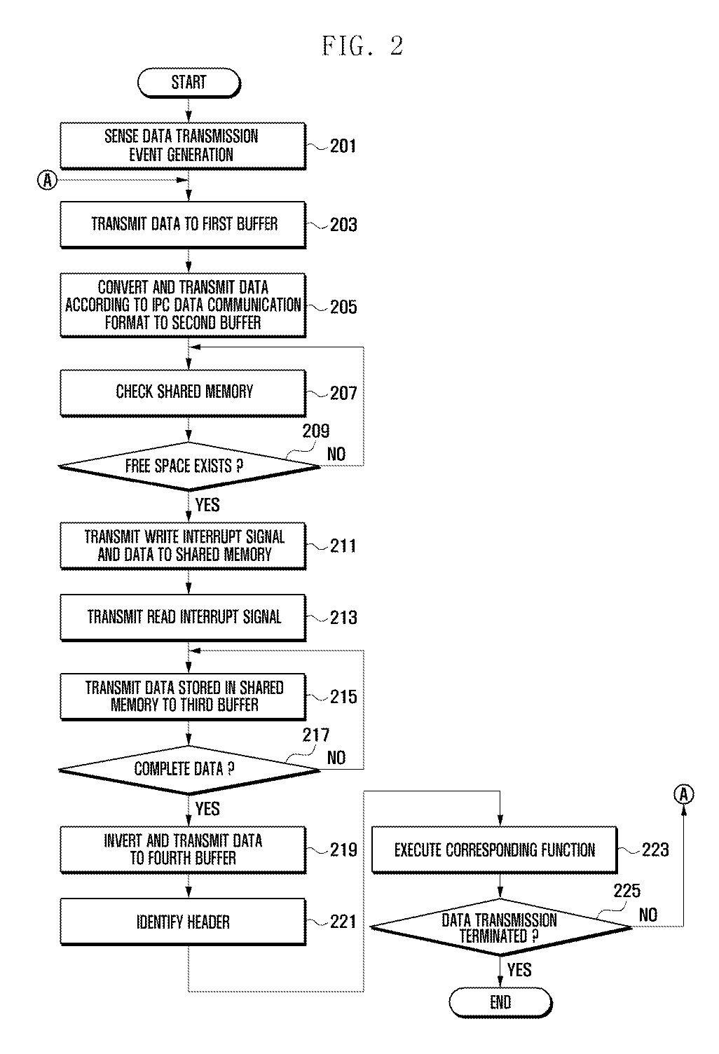

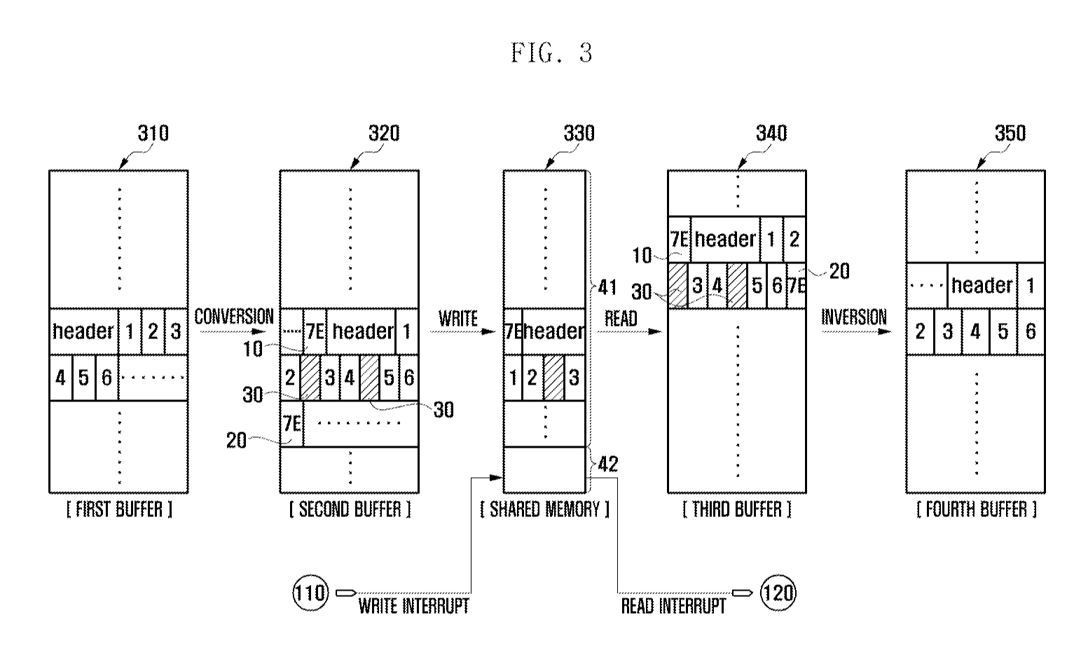

FIG. 2 is a flowchart illustrating a data communication method between processors of a portable terminal according to an exemplary embodiment of the present invention, and FIG. 3 is a block diagram illustrating a flow of data according to an exemplary embodiment of the present invention.

Referring to FIG. 2 and FIG. 3, a first control unit 110 according to an embodiment of the present invention may sense an event generation requesting data transmission to a second control unit 120 at step 201. Next, the first control unit 110 may store data to be transmitted in a first buffer 171 at step 203. At this time, the first control unit 110 may add a header to data to be transmitted, as indicated by reference numeral 310 of FIG. 3, and store the data with the header in a first buffer 171. Information regarding data type may be stored in the header. For example, information regarding data type such as ‘incoming call’ or ‘outgoing call’ may be stored in the heater in a case of call data. Information regarding data type such as ‘SMS’ may be stored in the heater in a case of Short Messaging Service (SMS).

Subsequently, the first control unit 110 may control transmission of data stored in the first buffer 171 to the second buffer 172 at step 205. At this time, the first control unit 110 may convert data according to an Inter-Process Communication (IPC) data communication format. As indicated by reference numeral 320 of FIG. 3, the first control unit 110 may add a start flag 10 and an end flag 20 according to an HDLC data transmission format, and perform bit stuffing and byte stuffing. Here, reference numeral 30 of part 320 is a meaningless data added due to the byte stuffing. Because the HDLC data transmission format is known in the art, a detailed description thereof is omitted.

The first control unit 110 may check a buffer area 41 storing data of a shared memory 140 at step 207, and check whether there is a free space in the buffer area 41 at step 209. When there is no free space in the buffer area 41, the first control unit 110 may return to step 207. Conversely, when there is a free space in the buffer area 41, the first control unit 110 may transmit a write interrupt signal to an interrupt area 42 of the shared memory 140 and transmit an amount of data corresponding to the free space from the data stored in the second buffer 172 to a buffer area 41 of the shared memory 140 at step 211.

When the shared memory 140 receives the write interrupt signal, it transmits a read interrupt signal to the second control unit 120 at step 213. When the second control unit 120 receives the read interrupt signal, it may read data stored in the shared memory 140 and store the read data in a third buffer 181 at step 215. As indicated by reference numeral 330 of FIG. 3, an amount of data corresponding to the free space and stored in the second buffer 172 is transmitted to a free space of a buffer area 41 of the shared memory 140, and data transmitted to the free space of the buffer area 41 is transmitted to a third buffer 181. As illustrated previously, data stored in the second buffer 172 is sequentially transmitted to the third buffer 181 through the shared memory 140 in units of the size of a free space of the buffer area 41.

Next, the second control unit 120 may check whether data stored in the third buffer 181 is complete data including a start flag and an end flag at step 217. When the data stored in the third buffer 181 is not complete data, the second control unit 120 may return to step 215. Conversely, when the data stored in the third buffer 181 is complete data, namely, as indicated by reference numeral 340 of FIG. 3, when data including a start flag and an end flag is transmitted to the third buffer 181, the second control unit 120 may control transmission of the complete data to the fourth buffer 182 at step 219. At this time, the second control unit 120 may invert data stored in the third buffer 181 and transmit the inverted data to the fourth buffer 182. For example, as indicated by reference numeral 350 of FIG. 3, the fourth buffer 182 may receive and store the inverted data from the third buffer 181.

Subsequently, the second control unit 120 may check a header of data stored in the fourth buffer 182 to identify a data type of data provided from the first control unit 110 at step 221, and execute a corresponding function at step 223. For example, when the data includes outgoing call data, the second control unit 120 transmits the data to a software module performing a call function. The software module performing the call function can transmit a call request signal to a base station through the second RF communication unit 160 using another user's phone number included in the data.

Next, the first control unit 110 may check whether data transmission is terminated at step 225. When the data transmission is not terminated, the first control unit 110 returns to step 203. When the data transmission is terminated, the first control unit 110 may terminate data communication between the processors.

Meanwhile, the foregoing exemplary embodiment has been described in that the first control unit 110 transmits data to the second control unit 120 by way of example. However, the present invention is not limited thereto. The present invention is equally applicable to a case where the second control unit 120 transmits the data to the first control unit 110. A dual standby terminal was described in the foregoing exemplary embodiment by way of example. The present invention is not limited thereto. That is, the present invention is applicable to a multi-standby terminal and a smart phone.

As illustrated earlier, since an exemplary embodiment of the present invention can transmit and receive data regardless of a size of a free space of a shared memory, efficient data communication is possible between processors (e.g., first control unit 110 and second control unit 120). Accordingly, an exemplary embodiment of the present invention acts to prevent bottleneck to secure stability of a portable terminal and to prevent performance deterioration due to the bottleneck. Further, an exemplary embodiment of the present invention can provide efficient data communication using a shared memory with a relative small capacity to reduce a cost of a portable terminal.

Meanwhile, a data communication method between processors of an exemplary embodiment of the present invention as mentioned above may be implemented in a program command form, capable of being performed through various computer means, recorded in a computer-readable recording medium. In this case, the computer-readable recording medium may include a program command, a data file, and a data structure separately or in a combination thereof. Meanwhile, the program command recorded in a recording medium may be a command designed or configured specially for an exemplary embodiment of the present invention, or usably known to a person having ordinary skill in the art.

The computer-readable recording medium includes a hardware device specially configured to store and execute a program command such as magnetic media such as a hard disc, a floppy disc, and a magnetic tape; optical media such as Compact Disc-Read Only Memory (CD-ROM) or Digital Versatile Disc (DVD); magneto-optical media such floptical disk; ROM; RAM; and flash memory.

Further, the program command includes a high level language code executable by a computer using an inter-print as well as a machine language code such as a code created by a compiler. The hardware device can be configured as at least one software module to execute an operation of an exemplary embodiment of the present invention.

While the invention has been shown and described with reference to certain exemplary embodiments thereof, it will be understood by those skilled in the art that various changes in form and details may be made therein without departing from the spirit and scope of the present invention as defined in the appended claims and their equivalents.

What is claimed is:

1. A data communication method between processors in a portable terminal comprising a plurality of processors, the method comprising:
storing data to be transmitted from a first processor to a second processor in a transmission buffer;
determining a size of a free space in a shared memory;
sequentially transmitting the data stored in the transmission buffer to the shared memory in units of the size of the free space; and
reading out the data transmitted to the shared memory and storing the read data in a reception buffer by a second processor.

2. The data communication method of claim 1, wherein the storing of the data in the transmission buffer comprises:
adding a header to the data to be transmitted and sequentially storing the data with the header in a first buffer; and
converting the data stored in the first buffer into an Inter-Process Communication (IPC) data communication format and storing the converted data in a second buffer.

3. The data communication method of claim 2, wherein the first buffer stores data in a circular queue scheme.

4. The data communication method of claim 2, wherein the IPC data communication format comprises a High-level Data Link Control (HDLC) data communication format.

5. The data communication method of claim 1, wherein the sequential transmission of the data to the shared memory further comprises transmitting a write interrupt signal to the shared memory when the free space is determined to exist.

6. The data communication method of claim 5, wherein the storing of the read data in the reception buffer comprises:
transmitting a read interrupt signal to the second processor by the shared memory when the shared memory receives the write interrupt signal;
reading out the data transmitted to the shared memory by the second processor and sequentially storing the read data in a third buffer when the second processor receives the read interrupt signal;
determining whether the read data stored in the third buffer comprises data comprising a complete format; and
inverting and transmitting the read data into a fourth buffer such that the fourth buffer stores the read data when the read data is determined to comprise data comprising the complete format.

7. The data communication method of claim 6, wherein the determination of whether the stored data comprises data comprising the complete format determines whether the data stored in the third buffer includes a start flag indicating a start of the data and an end flag indicating an end of the data.

8. The data communication method of claim 6, further comprising executing a corresponding function according to a data type included in a header of the data stored in the fourth buffer.

9. The data communication method of claim 6,
wherein the shared memory comprises an interrupt area, and
wherein the write interrupt signal is written to the interrupt area.

10. The data communication method of claim 1, wherein the transmission buffer and the reception buffer are included in one memory in a separated form.

11. A data communication apparatus between processors in a portable terminal comprising a plurality of processors, the apparatus comprising:
a transmission buffer for sequentially storing data that a first processor requests transmission of to a second processor;
a shared memory for performing a function of a medium for data communication between the first processor and the second processor;
a reception buffer for receiving and storing the data stored in the transmission buffer through the shared memory;
the first processor for determining a size of a free space of the shared memory and for controlling transmission of data stored in the transmission buffer to the shared memory in units of the size of the free space; and
the second processor for reading out the data stored in the shared memory and for controlling the reception buffer to store the read data.

12. The data communication apparatus of claim 11, wherein the transmission buffer comprises:
a first buffer for adding a header with a data type to the data to be requested for transmission and for storing the data with the header; and
a second buffer for converting the data stored in the first buffer into an Inter-Process Communication (IPC) data communication format and for storing the converted data.

13. The data communication apparatus of claim 12, wherein the first buffer stores data in a circular queue scheme.

14. The data communication apparatus of claim 12, wherein the IPC data communication format comprises a High-level Data Link Control (HDLC) data communication format.

15. The data communication apparatus of claim 13, wherein the reception buffer comprises:
a third buffer for reading out the data stored in the shared memory and for sequentially the read data; and
a fourth buffer for inverting and storing the data stored in the third buffer.

16. The data communication apparatus of claim 15, wherein the second processor inverts and transmits the data stored in the third buffer to the fourth buffer when the stored data is determined to comprise data of complete format including a start flag indicating a start of the data and an end flag indicating an end of the data.

17. The data communication apparatus of claim 16, wherein the second processor executes a corresponding function according to a data type included in a header of the data stored in the fourth buffer.

18. The data communication apparatus of claim 13, wherein the shared memory comprises a dual-port Random Access Memory (RAM).

19. The data communication apparatus of claim 13, wherein the shared memory comprises:
a buffer area for storing data provided from the transmission buffer; and
an interrupt area for transmitting a read interrupt signal to the second processor when a write interrupt signal is received from the first processor.

20. The data communication apparatus of claim 11, wherein the transmission buffer and the reception buffer are included in one memory in a separated form.
